(19) United States
(12) Patent Application Publication
(10) Pub. No.: US 2024/0427530 A1
(43) Pub. Date: Dec. 26, 2024

(54) PRINTING APPARATUS CAPABLE OF IMPROVING OPERABILITY WHEN SELECTING PRINT SETTING BY USING INFORMATION PROCESSING APPARATUS, CONTROL METHOD FOR PRINTING APPARATUS, AND STORAGE MEDIUM

(71) Applicant: CANON KABUSHIKI KAISHA, Tokyo (JP)

(72) Inventor: Kenta Matsui, Ibaraki (JP)

(21) Appl. No.: 18/731,529

(22) Filed: Jun. 3, 2024

(30) Foreign Application Priority Data
Jun. 22, 2023 (JP) 2023-102482

(51) Int. Cl. G06F 3/12

(52) U.S. Cl. CPC G06F 3/1204; G06F 3/1257

(57) ABSTRACT

A printing apparatus capable of improving operability when selecting a print setting by using an information processing apparatus is provided. The printing apparatus performing printing and communicably connected to the information processing apparatus includes at least one processor, and a memory coupled to the processor storing instructions that, when executed by the processor, cause the processor to function as a registering section registering a plurality of print settings having different output conditions including printing conditions, a transmitting unit transmitting at least one print setting to the information processing apparatus, a determining section that, prior to transmission of the print setting performed by the transmitting unit, determines a priority order for the plurality of print settings registered in the registering section, and a control unit exchanging an order of the plurality of print settings to be transmitted into the priority order when the transmitting unit transmits the plurality of print settings.

### BACKGROUND OF THE INVENTION

### Field of the Invention

The present invention relates to a printing apparatus, a control method for the printing apparatus, and a storage medium.

### Description of the Related Art

A printing apparatus that performs printing is communicably connected to an information processing apparatus (for example, a personal computer, or the like) capable of processing information to and from the printing apparatus. In addition, the printing apparatus and the information processing apparatus are able to communicate with each other based on the internet printing protocol (the IPP). As a result, it is possible to issue a printing instruction from the information processing apparatus to the printing apparatus without using a printer driver specifically designed for the printing apparatus. In addition, the IPP allows setting information regarding a print setting (a printing condition) to be stored in the printing apparatus. This setting information is transmitted from the printing apparatus to the information processing apparatus in response to a request from the information processing apparatus. In addition, the information processing apparatus is able to reflect this setting information in a print document. A user is able to register the setting information regarding the print setting as a preset in the printing apparatus. This registration is sometimes referred to as “an IPP preset”. In addition, the user is also able to select the preset registered in the printing apparatus by using the information processing apparatus. As a result, it is possible to reflect the preset (the setting information) selected by the information processing apparatus in the print document in the printing apparatus. Japanese Laid-Open Patent Publication (kokai) No. 2020-97179 discloses a printing apparatus capable of performing printing based on the IPP preset.

However, since the more presets registered in the printing apparatus, the more presets will be displayed on the information processing apparatus, it may be difficult to search for or select a desired preset from among these presets.

### SUMMARY OF THE INVENTION

The present invention provides a printing apparatus capable of improving operability when selecting a print setting by using an information processing apparatus, a control method for the printing apparatus, and a storage medium.

Accordingly, the present invention provides a printing apparatus that performs printing and is communicably connected to an information processing apparatus, which processes information, the printing apparatus comprising at least one processor, and a memory coupled to the processor storing instructions that, when executed by the processor, cause the processor to function as a registering section that registers a plurality of print settings, which have different output conditions including printing conditions when performing the printing with the printing apparatus, a transmitting unit that transmits at least one print setting of the plurality of print settings to the information processing apparatus, a determining section that, prior to transmission of the print setting performed by the transmitting unit, determines a priority order with respect to the plurality of print settings, which have been registered in the registering section, and a control unit that exchanges an order of the plurality of print settings to be transmitted into the priority order when the transmitting unit transmits the plurality of print settings.

According to the present invention, it is possible to improve the operability when selecting the print setting by using the information processing apparatus.

Further features of the present invention will become apparent from the following description of exemplary embodiments with reference to the attached drawings.

### BRIEF DESCRIPTION OF THE DRAWINGS

FIG. 1 is a schematic diagram of a printing system according to a first embodiment.

FIG. 2 is a block diagram that shows a hardware configuration of a printing apparatus.

FIG. 3 is a block diagram that shows a software configuration of the printing apparatus.

FIG. 4 is a block diagram that shows a hardware configuration of an information processing apparatus.

FIG. 5 is a block diagram that shows a software configuration of the information processing apparatus.

FIG. 6 is a sequence diagram that shows processes executed between a user, the information processing apparatus, and the printing apparatus.

FIG. 7A and FIG. 7B are flowcharts that show a processing from registering a preset in the printing apparatus to receiving a print job, in which a preset has been set, from the information processing apparatus and printing the received print job.

FIG. 8 is a flowchart that shows a processing executed by the information processing apparatus when obtaining preset information from the printing apparatus and performing printing using the preset.

FIG. 9A and FIG. 9B are diagrams that show examples of a preset management table.

FIG. 10 is a diagram that shows an example of a print setting screen.

FIG. 11A, FIG. 11B, and FIG. 11C are diagrams that show an example of a preset management screen.

FIG. 12 is a diagram that shows an example of printer attributes.

FIG. 13A, FIG. 13B, and FIG. 13C are diagrams that show an example of the print setting screen.

FIG. 14A and FIG. 14B are flowcharts that show a processing from registering a preset in a printing apparatus to receiving a print job, in which a preset has been set, from an information processing apparatus and printing the received print job, in a printing system according to a second embodiment.

### DESCRIPTION OF THE EMBODIMENTS

The present invention will now be described in detail below with reference to the accompanying drawings showing embodiments thereof.

Hereinafter, each embodiment of the present invention will be described in detail with reference to the drawings. However, the configuration described in each embodiment below is merely an example, and the scope of the present invention is not limited by the configuration described in each embodiment. For example, each unit (each component) constituting the present invention can be replaced with a unit (a component) with any configuration that can perform the same function. In addition, any components may be added. Furthermore, any two or more configurations (features) of each embodiment can be combined.

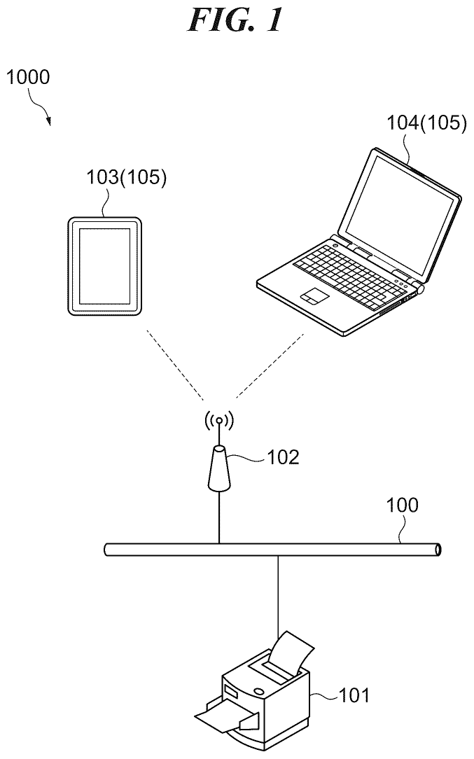

A first embodiment of the present invention will be described below with reference to FIGS. 1 to 13C.

FIG. 1 is a schematic diagram of a printing system according to the first embodiment. As shown in FIG. 1, a printing system 1000 includes a printing apparatus 101 that performs printing and information processing apparatuses 105 that perform information processing. The printing apparatus 101 and the information processing apparatuses 105 are communicably connected to each other via an access point (an AP) 102 and a local area network (a LAN) 100. It should be noted that this communication may be wireless communication or wired communication. In the present embodiment, a terminal device 103 and a terminal device 104 are arranged as the information processing apparatuses 105. Although the terminal device 103 is a tablet terminal or a smartphone in the configuration shown in FIG. 1, the terminal device 103 is not limited to this, and may be, for example, a desktop personal computer or a notebook personal computer. In addition, although the terminal device 104 is a notebook personal computer in the configuration shown in FIG. 1, the terminal device 104 is not limited to this, and may be, for example, a desktop personal computer, a tablet terminal, or a smartphone. It should be noted that the number of the information processing apparatuses 105 arranged in the printing system 1000 is two in the present embodiment, but is not limited to this, and for example, may be one or three or more. The printing apparatus 101 is not particularly limited, and may be, for example, a multi-function peripheral (an MFP) or a single-function printer (an SFP).

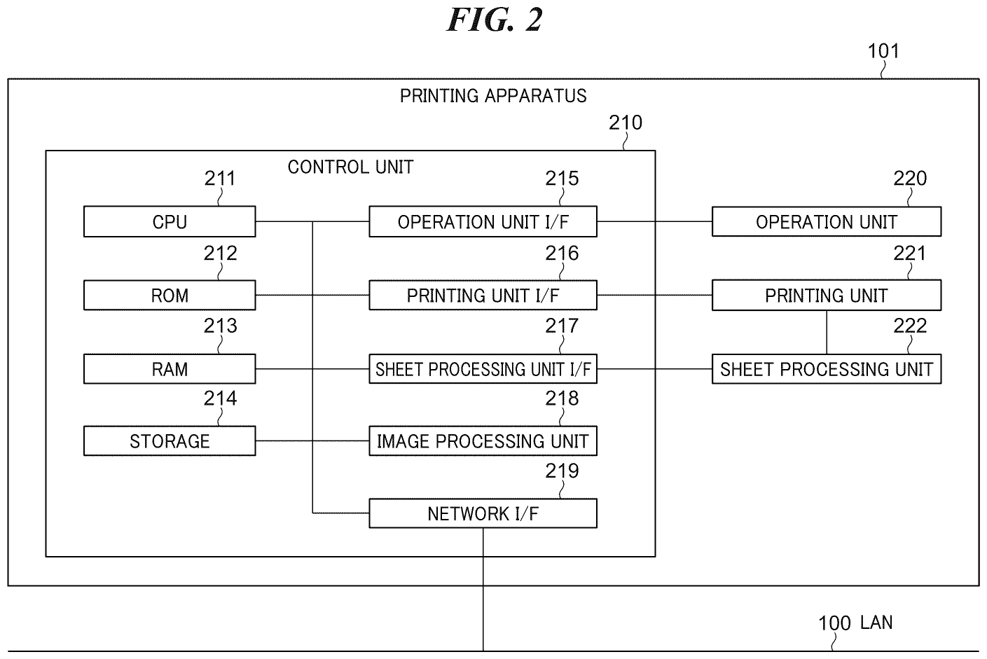

Next, a hardware configuration of the printing apparatus will be described. FIG. 2 is a block diagram that shows the hardware configuration of the printing apparatus. The printing apparatus 101 shown in FIG. 2 includes a print function of printing an image on a sheet (a recording medium), and executes a print processing based on a print job received via the LAN 100. “The print job” includes a print setting such as the number of copies to be printed, color printing/monochrome printing, single-sided printing/double-sided printing, etc., and a print document (for example, a PDF document) in which the print setting is reflected. The printing apparatus 101 includes a control unit 210, an operation unit 220, a printing unit (a printer engine) 221, and a sheet processing unit 222. The control unit 210 comprehensively controls the overall operation of the printing apparatus 101. The control unit 210 includes a central processing unit (a CPU) 211, a read only memory (a ROM) 212, a random access memory (a RAM) 213, and a storage 214. In addition, the control unit 210 includes an operation unit interface (an operation unit I/F) 215, a printing unit interface (a printing unit I/F) 216, a sheet processing unit interface (a sheet processing unit I/F) 217, an image processing unit 218, and a network interface (a network I/F) 219.

The CPU 211 is a computer that loads a program stored in the ROM 212 or the storage 214 into the RAM 213 and executes it to perform printing control. The ROM 212 stores control programs, boot programs, etc., which are executable by the CPU 211. These control programs include, for example, programs, etc., which cause the CPU 211 to execute respective units and respective steps of the printing apparatus 101 (a control method for the printing apparatus). The RAM 213 is a main storage memory of the CPU 211, and is used as a working area, or a temporary storage area for loading various kinds of control programs. The storage 214 stores print jobs, image data, various kinds of programs, and various kinds of setting information. Although a hard disk drive (an HDD) is used as the storage 214 in the present embodiment, the present invention is not limited to this, and for example, a solid state drive (an SSD) or the like may be used as the storage 214. It should be noted that in the control unit 210, one CPU 211, one ROM 212, one RAM 213, and one storage 214 are arranged, but the present invention is not limited to this, and a plurality of CPUs 211, a plurality of ROMs 212, a plurality of RAMs 213, and a plurality of storages 214 may be arranged in the control unit 210.

The operation unit I/F 215 is an interface that connects the operation unit 220 and the control unit 210. The operation unit 220 includes, for example, a display unit with a touch panel function, various kinds of hardware keys, and the like. Thereby, by operating the operation unit 220, it is possible to accept instructions from a user. In addition, the operation unit 220 is able to display various kinds of information on the display unit. The printing unit I/F 216 is an interface that connects the printing unit 221 and the control unit 210. A print job from the information processing apparatus 105 is transferred from the control unit 210 to the printing unit 221 via the printing unit I/F 216. The printing unit 221 receives a control command from the control unit 210 in addition to the print job. Thereby, the printing unit 221 is able to print an image on a sheet fed from a sheet feeding cassette based on the print job. The printing unit 221 according to the present embodiment is capable of printing on at least one type of sheet of types of sheets fed from the sheet feeding cassette. The printer attribute of the sheet type is notified to the control unit 210 in advance (for example, when starting up the printing apparatus 101) via the printing unit I/F 216, and is stored in the RAM 213 or the storage 214. In addition, the printing method used in the printing unit 221 is not particularly limited, and may be, for example, an inkjet method, an 5 electrophotographic method, a thermal transfer method, or the like. The sheet processing unit I/F 217 is an interface that connects the control unit 210 and the sheet processing unit 222. The sheet processing unit 222 receives a control command from the control unit 210 and performs post-processing on the sheets printed by the printing unit 221 in accordance with the control command. The post-processing after printing is not particularly limited, and examples of the post-processing after printing include a processing of aligning a plurality of sheets, a processing of punching holes in sheets, a processing of binding a plurality of sheets, etc. Furthermore, the control unit 210 is connected to the LAN 100 via the network I/F 219. The network I/F 219 transmits various kinds of information such as image data to the information processing apparatus 105 on the LAN 100, and receives various kinds of information such as print jobs from the information processing apparatus 105 on the LAN 100.

The image processing unit 218 includes a raster image processor function (a RIP function). “The RIP function” is a function that develops a print job received via the LAN 100 and generates image data used for printing. The image processing unit 218 is also able to perform a resolution conversion processing and a correction processing with respect to the image data. It should be noted that although the image processing unit 218 is configured with a hardware circuit (such as an application-specific integrated circuit (an ASIC) or a field programmable gate array (an FPGA)) in the present embodiment, it is not limited thereto, and for example, may be configured with a processor for image processing. In the case that the image processing unit 218 is configured with a processor for image processing, when the processor for image processing executes an image processing program, the image data generation processing, the resolution conversion processing, and the correction processing become possible. Further, the CPU 211 may execute a program for performing the image processing to perform the image processing and the like.

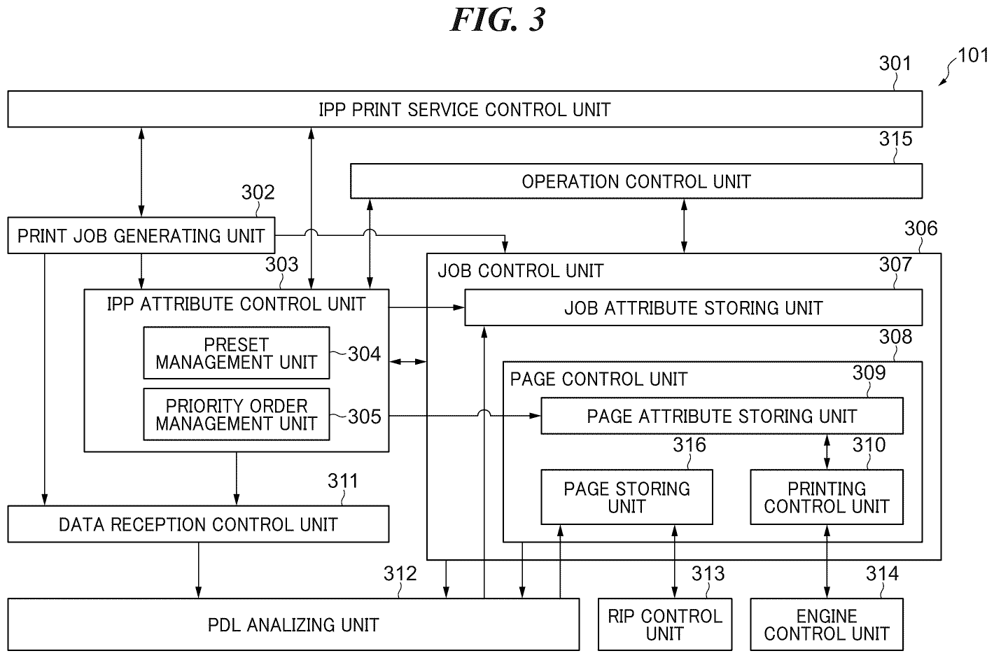

Next, a software configuration of the printing apparatus will be described. FIG. 3 is a block diagram that shows the software configuration of the printing apparatus. It should be noted that in the present embodiment, it is assumed that each functional block shown in FIG. 3 is implemented by the CPU 211 executing a program loaded in the RAM 213. As shown in FIG. 3, the printing apparatus 101 includes an IPP print service control unit 301, a print job generating unit 302, an IPP attribute control unit 303, and a job control unit 306. In addition, the printing apparatus 101 includes a data reception control unit 311, a PDL analyzing unit 312, a RIP control unit 313, an engine control unit 314, and an operation control unit 315. The IPP attribute control unit 303 includes a preset management unit 304 and a priority order management unit 305. The job control unit 306 includes a job attribute storing unit 307 and a page control unit 308. The page control unit 308 includes a page attribute storing unit 309, a printing control unit 310, and a page storing unit 316.

The IPP print service control unit 301 summarizes preset information, which is registered in the printing apparatus 101 and is managed by the preset management unit 304, and functions executable by the printing apparatus 101 and notifies the information processing apparatus 105 as printer attributes of the printing apparatus 101. In addition, in the case that the IPP print service control unit 301 receives a print job based on the internet printing protocol (the IPP) from the information processing apparatus 105 via the LAN 100, the IPP print service control unit 301 transmits the print job to the print job generating unit 302. The print job generating unit 302 receives the print job from the information processing apparatus 105 via the IPP print service control unit 301. Then, the print job generating unit 302 writes this print job into the data reception control unit 311, registers it as a new job in the job control unit 306, and requests the start of the print processing. In addition, the print job generating unit 302 transmits print setting information applied to the print job to the job attribute storing unit 307.

The data reception control unit 311 is a buffer area for print jobs received by the print job generating unit 302. Thereby, it is possible to temporarily store each print job in the storage 214. In the case that the job control unit 306 instructs the PDL analyzing unit 312 to perform a PDL analysis processing of the print job, the PDL analyzing unit 312 requests the data reception control unit 311 for the print job. Thereby, the data reception control unit 311 transmits the print job to the PDL analyzing unit 312. The PDL analyzing unit 312 generates intermediate data according to the PDL language specifications. This intermediate data is stored in the page storing unit 316. Attributes stored in the job attribute storing unit 307 include various kinds of printing conditions when printing is performed by the printing apparatus 101. The printing conditions are not particularly limited, and include, for example, “sheet type”, “number of copies”, “Nup (combined printing)”, “print side (single-sided/double-sided) setting”, “color/monochrome”, etc., which are set as IPP job attributes. Furthermore, in addition to the printing conditions, post-processing conditions after printing such as “finishing setting” are also included. The printing conditions and the post-processing conditions, that is, output conditions, are all managed in the job attribute storing unit 307 in association with a job ID.

The page control unit 308 controls a page analysis processing performed by the PDL analyzing unit 312, a RIP processing performed by the RIP control unit 313, and a printing control processing performed by the printing control unit 310. The page control unit 308 transmits the intermediate data, which is generated by the PDL analyzing unit 312 and is stored in the page storing unit 316, to the RIP control unit 313. The RIP control unit 313 renders the intermediate data to generate image data. The page control unit 308 transmits the image data generated by the RIP control unit 313 to the printing control unit 310. The printing control unit 310 color-separates the image data into CMYK and transfers it to the engine control unit 314. The engine control unit 314 receives the image data color-separated into CMYK for each page from the printing control unit 310, and controls the printing unit 221 to execute the print processing for each page.

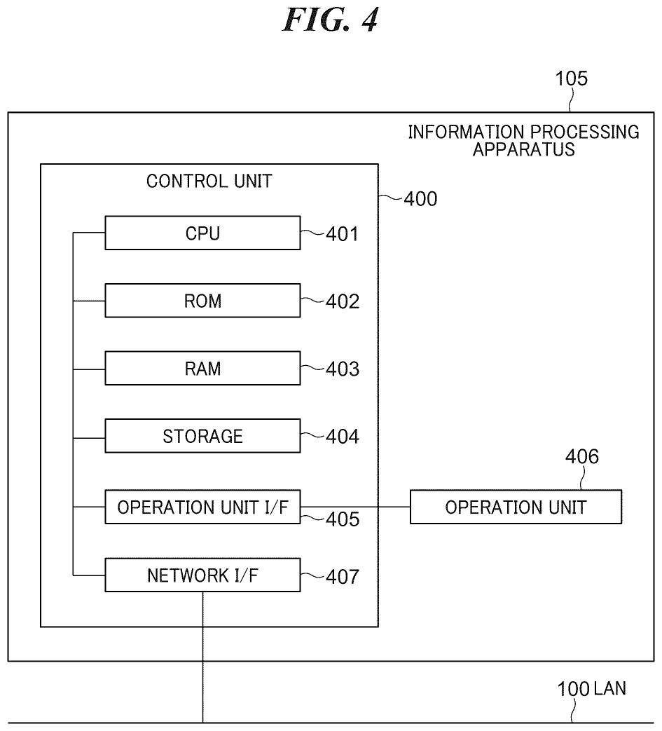

Next, a hardware configuration of the information processing apparatus will be described. FIG. 4 is a block diagram that shows the hardware configuration of the information processing apparatus. As shown in FIG. 4, the information processing apparatus 105 includes a control unit 400 and an operation unit 406. The control unit 400 comprehensively controls the overall operation of the information processing apparatus 105. The control unit 400 includes a CPU 401, a ROM 402, a RAM 403, a storage 404, an operation unit I/F 405, and a network I/F 407. The CPU 401 is a computer that loads a program stored in the ROM 402 or the storage 404 into the RAM 403 and executes it to perform arithmetic processing. The ROM 402 stores control programs, boot programs, etc., which are executable by the CPU 401. The RAM 403 is a main storage memory of the CPU 401, and is used as a working area, or a temporary storage area for loading various kinds of control programs. The storage 404 stores application data, print jobs, various kinds of programs, and various kinds of setting information. Although an SSD is used as the storage 404 in the present embodiment, the present invention is not limited to this, and for example, an HDD or the like may be used as the storage 404. It should be noted that in the control unit 400, one CPU 401, one ROM 402, one RAM 403, and one storage 404 are arranged, but the present invention is not limited to this, and a plurality of CPUs 401, a plurality of ROMs 402, a plurality of RAMs 403, and a plurality of storages 404 may be arranged in the control unit 400. The operation unit I/F 405 is an interface that connects the operation unit 406 and the control unit 400. The operation unit 406 includes, for example, a display unit with a touch function. Thereby, by operating the operation unit 406, it is possible to accept instructions from the user. In addition, the operation unit 406 is able to display various kinds of information on the display unit. Furthermore, the control unit 400 is connected to the AP 102 via the network I/F 407.

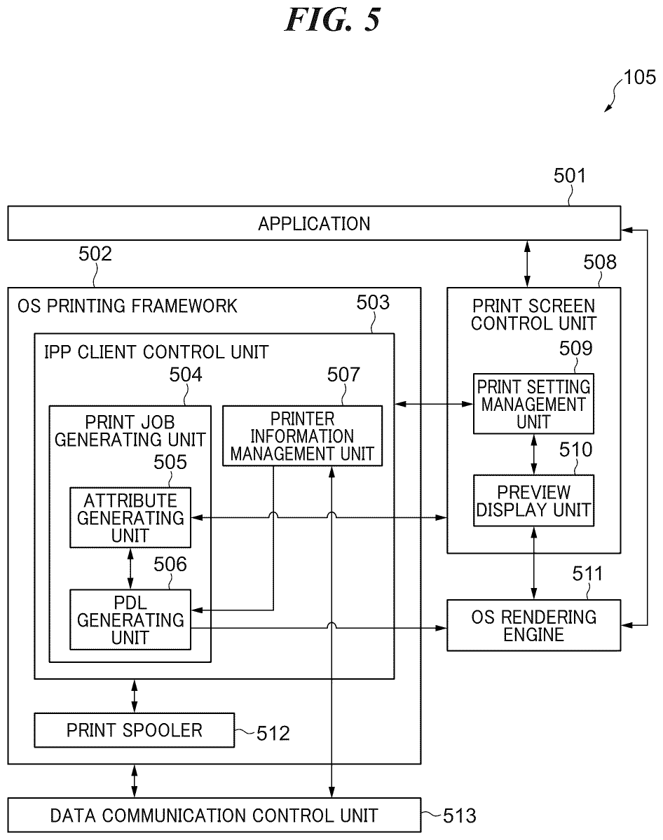

Next, a software configuration of the information processing apparatus will be described. FIG. 5 is a block diagram that shows the software configuration of the information processing apparatus. It should be noted that in the present embodiment, it is assumed that each functional block shown in FIG. 5 is implemented by the CPU 401 executing a program loaded in the RAM 403. As shown in FIG. 5, the information processing apparatus 105 includes an application 501, an OS printing framework 502, a print screen control unit 508, an OS rendering engine 511, and a data communication control unit 513. The OS printing framework 502 includes an IPP client control unit 503 and a print spooler 512. The IPP client control unit 503 includes a print job generating unit 504 and a printer information management unit 507. The print job generating unit 504 includes an attribute generating unit 505 and a PDL generating unit 506. The print screen control unit 508 includes a print setting management unit 509 and a preview display unit 510. In addition, the information processing apparatus 105 also includes an operating system (an OS).

The application 501 is an application that runs on the information processing apparatus 105, and is able to provide the user with general application functions such as word processing and spreadsheet processing. In addition, the application 501 is able to render a graphical user interface (a GUI) for user operations and generate data for printing via the OS rendering engine 511 provided by the OS of the information processing apparatus 105. When the user calls out the print function on the application 501, the application 501 calls out the print screen control unit 508. As described above, the print screen control unit 508 includes the print setting management unit 509 and the preview display unit 510. The print setting management unit 509 obtains the printer attributes of the printing apparatus 101 from the printer information management unit 507 and generates a user interface screen (a UI screen) for print setting that matches the capabilities of the printing apparatus 101. The preview display unit 510 displays each page data generated by the application 501 via the OS rendering engine 511 together with the print setting of the print setting management unit 509.

In addition, as described above, the OS printing framework 502 includes the IPP client control unit 503 and the print spooler 512. Furthermore, the IPP client control unit 503 includes the print job generating unit 504 and the printer information management unit 507. The print job generating unit 504 generates a print job according to an instruction from the print screen control unit 508. The printer information management unit 507 holds the printer attributes of the printing apparatus 101 obtained from the printing apparatus 101. The printer information management unit 507 obtains the printer attributes from the printing apparatus 101 via the data communication control unit 513 and transmits them to the print screen control unit 508. The print spooler 512 sequentially transfers print jobs generated by the IPP client control unit 503 to the printing apparatus 101 via the data communication control unit 513.

In addition, as described above, the print job generating unit 504 includes the attribute generating unit 505 and the PDL generating unit 506. The attribute generating unit 505 and the PDL generating unit 506 start processing upon receiving a print document generation instruction from the print screen control unit 508. The attribute generating unit 505 generates attribute information of the IPP job according to an instruction from the print setting management unit 509. The PDL generating unit 506 obtains the page data generated by the OS rendering engine 511 in page order, converts it into the PDL language that can be processed by the printing apparatus 101, and transmits it. The PDL format that can be processed by the printing apparatus 101 is obtained from the printer information management unit 507.

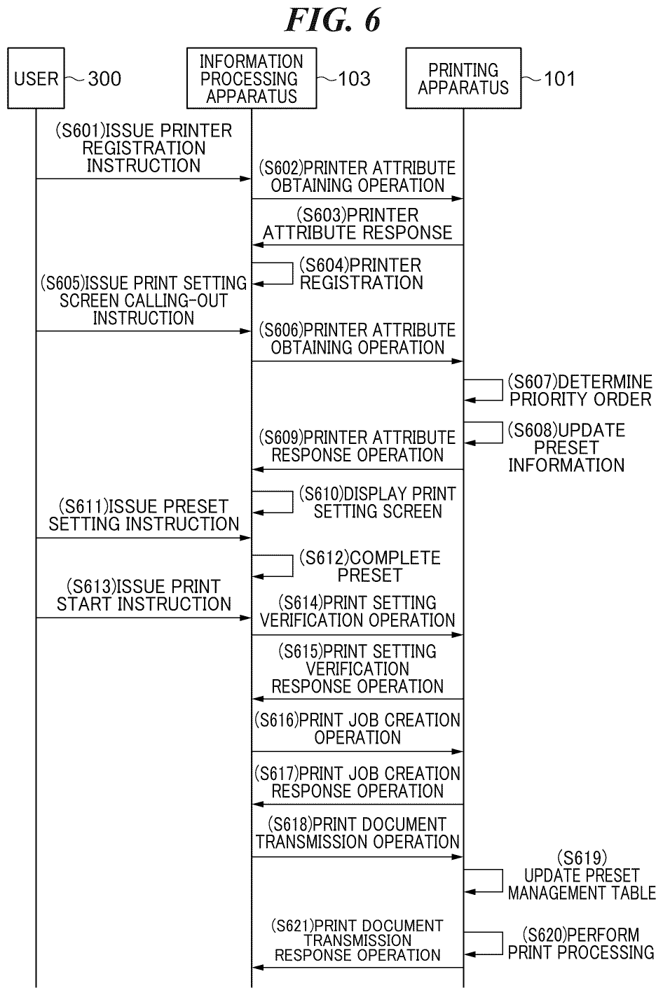

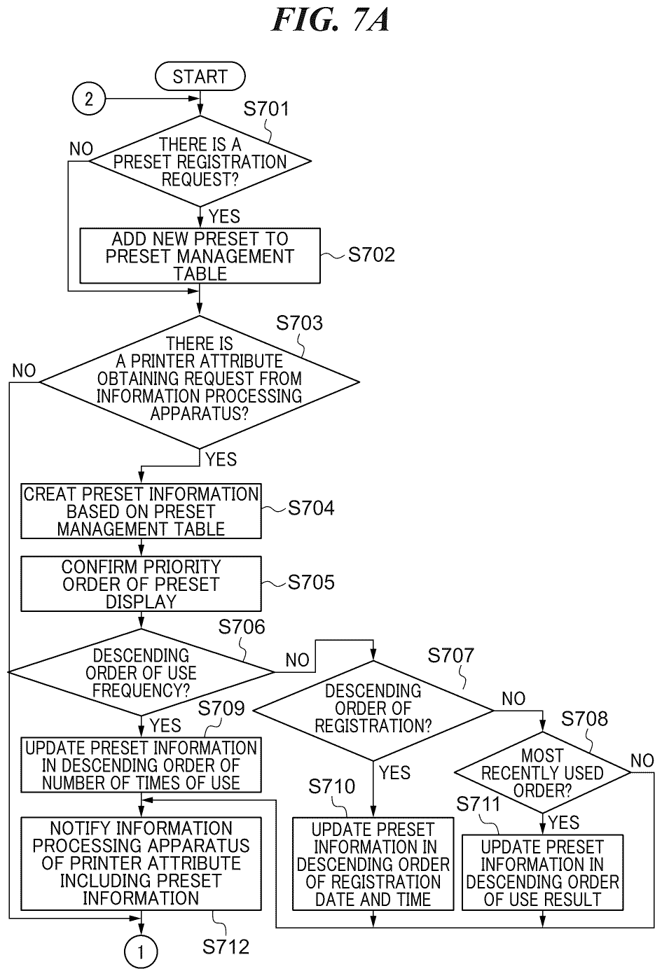

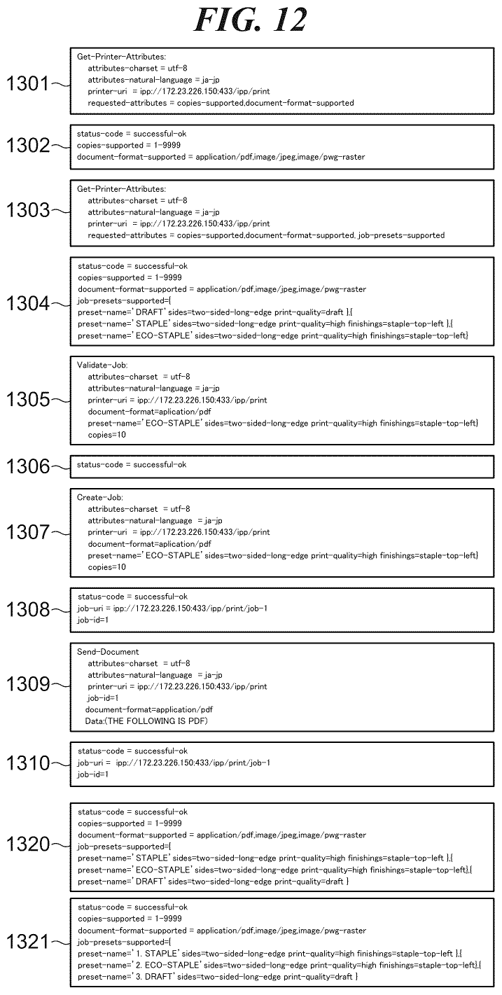

FIG. 6 is a sequence diagram that shows processes executed between the user, the information processing apparatus, and the printing apparatus. FIG. 12 is a diagram that shows an example of the printer attributes. Here, a printing sequence in which a user 300 causes the printing apparatus 101 to print by using a preset displayed on the information processing apparatus 105 will be described. In a step S601, the user 300 operates the operation unit 406 of the information processing apparatus 105 to issue a printer registration instruction to the information processing apparatus 105.

In a step S602, in the case that the information processing apparatus 105 receives the printer registration instruction issued in the step S601, the information processing apparatus 105 generates a printer attribute obtaining operation 1301 (see FIG. 12) and transmits it to the printing apparatus 101.

In a step S603, in the case that the printing apparatus 101 receives the printer attribute obtaining operation 1301 generated in the step S602, the printing apparatus 101 generates a printer attribute response 1302 (see FIG. 12) and transmits it to the information processing apparatus 105. Thereby, the information processing apparatus 105 is able to receive the printer attribute response 1302.

In a step S604, the information processing apparatus 105 stores the printer attributes in the RAM 403, and completes the printer registration.

In a step S605, the user 300 operates the operation unit 406 of the information processing apparatus 105 to issue a print setting screen calling-out instruction, which calls out a print setting screen, to the information processing apparatus 105.

In a step S606, in the case that the information processing apparatus 105 receives the print setting screen calling-out instruction issued in the step S605, the information processing apparatus 105 generates a printer attribute obtaining operation 1303 (see FIG. 12) and transmits it to the printing apparatus 101.

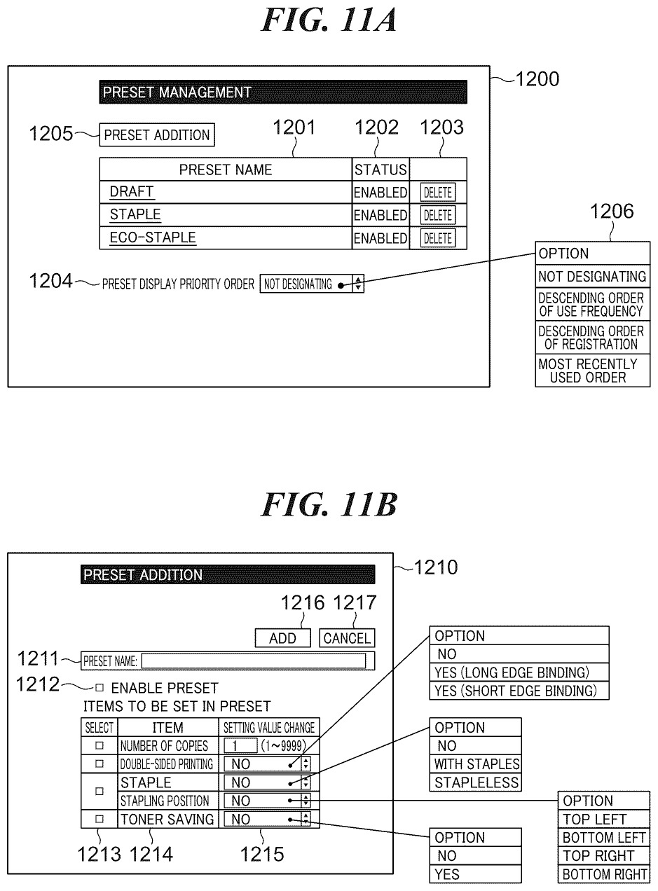

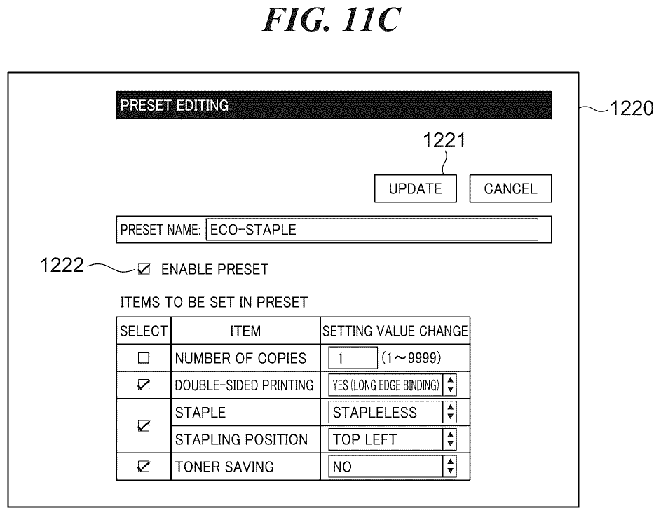

In a step S607, in the case that the printing apparatus 101 receives the printer attribute obtaining operation 1303 generated in the step S606, the printing apparatus 101 determines a priority order of presets to be displayed on the information processing apparatus 105. In the present embodiment, the priority order of presets is determined based on the following four options (the following four determining conditions). The first option is “not designating the priority order”. The second option is “a descending order of a use frequency”, that is, “a descending order of a use frequency of the print setting in the printing apparatus 101”. The third option is “a descending order of registration”, that is, “a descending order of a registration date and time of the print setting”. The fourth option is “a most recently used order”, that is, “a descending order of a last use date and time of the print setting in the printing apparatus 101”. In addition, these options are set in the printing apparatus 101 (see a preset display priority order 1204 shown in FIG. 11A).

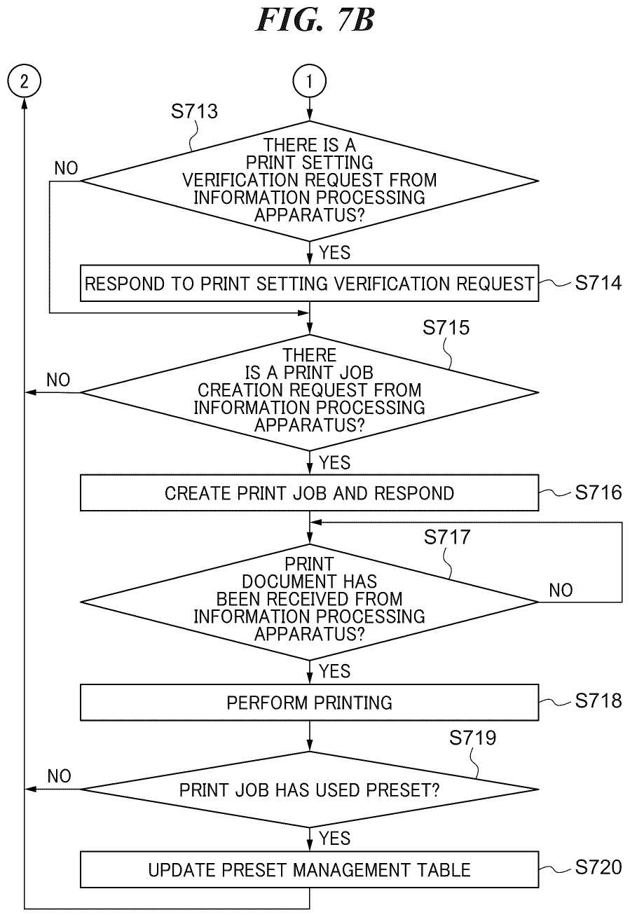

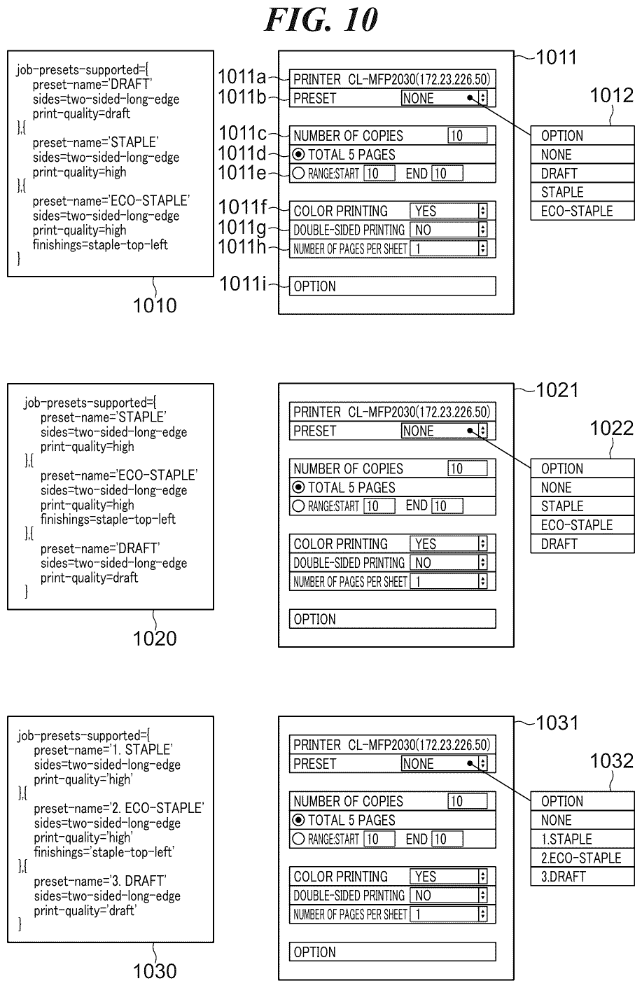

In a step S608, the printing apparatus 101 updates preset information 1010 (see FIG. 10) according to the priority order determined in the step S607. It should be noted that details of the priority order determining processing performed in the step S607 and details of the preset information updating processing performed in the step S608 will be described below with reference to FIG. 7A and FIG. 7B.

In a step S609, the printing apparatus 101 generates a printer attribute response operation 1304 (see FIG. 12) based on the preset information 1010 updated in the step S608, and transmits it to the information processing apparatus 105.

In a step S610, in the case that the information processing apparatus 105 receives the printer attribute response operation 1304 generated in the step S609, the information processing apparatus 105 displays a print setting screen 1011 (see FIG. 10) on the operation unit 406.

In a step S611, the user 300 operates the operation unit 406 of the information processing apparatus 105 to issue a preset setting instruction to the information processing apparatus 105.

In a step S612, in the case that the information processing apparatus 105 receives the preset setting instruction issued in the step S611, the information processing apparatus 105 displays options 1012 (see FIG. 10) as a list of presets based on the printer attribute response operation 1304. Then, the information processing apparatus 105 stores the preset that has been instructed to be set by the user 300 in the RAM 403, and completes the preset setting.

In a step S613, the user 300 operates the operation unit 406 of the information processing apparatus 105 to issue a print start instruction to the information processing apparatus 105.

In a step S614, the information processing apparatus 105 transmits a print setting verification operation 1305 (see FIG. 12) to the printing apparatus 101 based on the information designated by the print start instruction issued in the step S613.

In a step S615, in the case that the printing apparatus 101 receives the print setting verification operation 1305 transmitted in the step S614, the printing apparatus 101 determines whether or not printing is possible based on the setting of the print setting verification operation 1305. As a result of this determination, in the case that the printing apparatus 101 determines that printing is possible based on the setting of the print setting verification operation 1305, the printing apparatus 101 generates a print setting verification response operation 1306 (see FIG. 12) that includes “status-code=successful-ok” indicating success, and transmits it to the information processing apparatus 105.

In a step S616, in the case that the information processing apparatus 105 receives the print setting verification response operation 1306 generated in the step S615, the information processing apparatus 105 transmits a print job creation operation 1307 (see FIG. 12) to the printing apparatus 101.

In a step S617, in the case that the printing apparatus 101 receives the print job creation operation 1307 transmitted in the step S616, the printing apparatus 101 transmits a print job creation response operation 1308 (see FIG. 12) to the information processing apparatus 105.

In a step S618, in the case that the information processing apparatus 105 receives the print job creation response operation 1308 transmitted in the step S617, the information processing apparatus 105 transmits a print document transmission operation 1309 (see FIG. 12) to the printing apparatus 101.

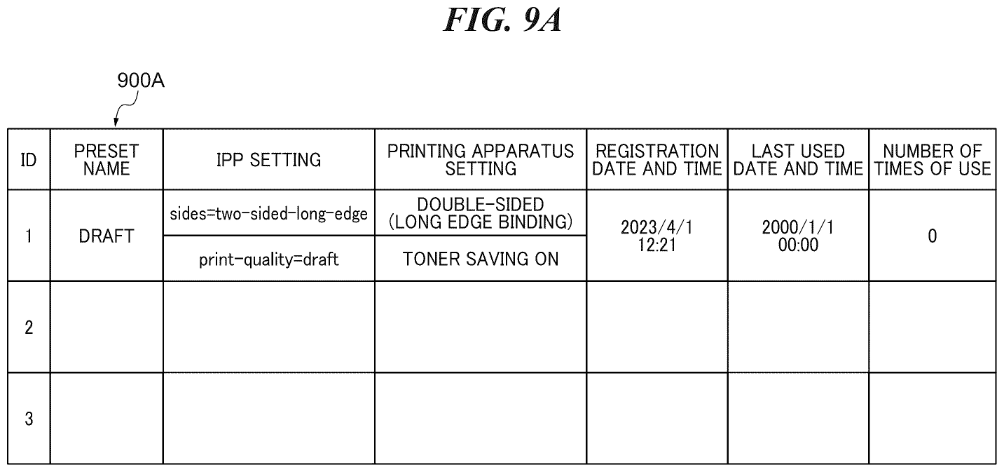

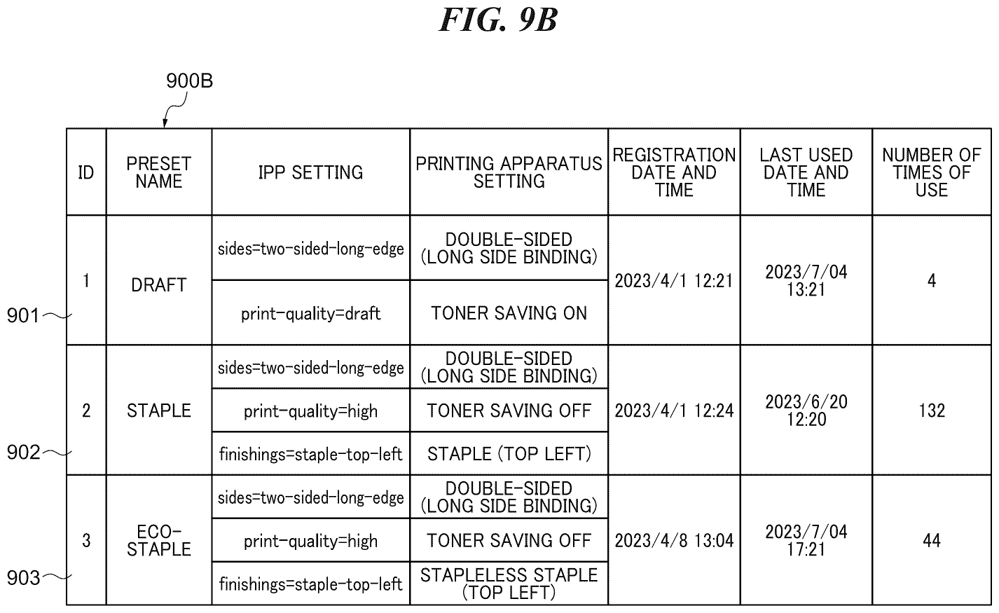

In a step S619, in the case that the printing apparatus 101 receives the print document transmission operation 1309 transmitted in the step S618, the printing apparatus 101 updates a preset management table 900A (see FIG. 9A). It should be noted that details of the preset management table updating processing performed in the step S619 will be described below with reference to FIG. 7A and FIG. 7B.

In a step S620, the printing apparatus 101 performs the print processing based on the information designated in the print job creation operation 1307 transmitted in the step S616.

In a step S621, the printing apparatus 101 transmits a print document transmission response operation 1310 (see FIG. 12) that includes “status-code=successful-ok” indicating success of printing to the information processing apparatus 105.

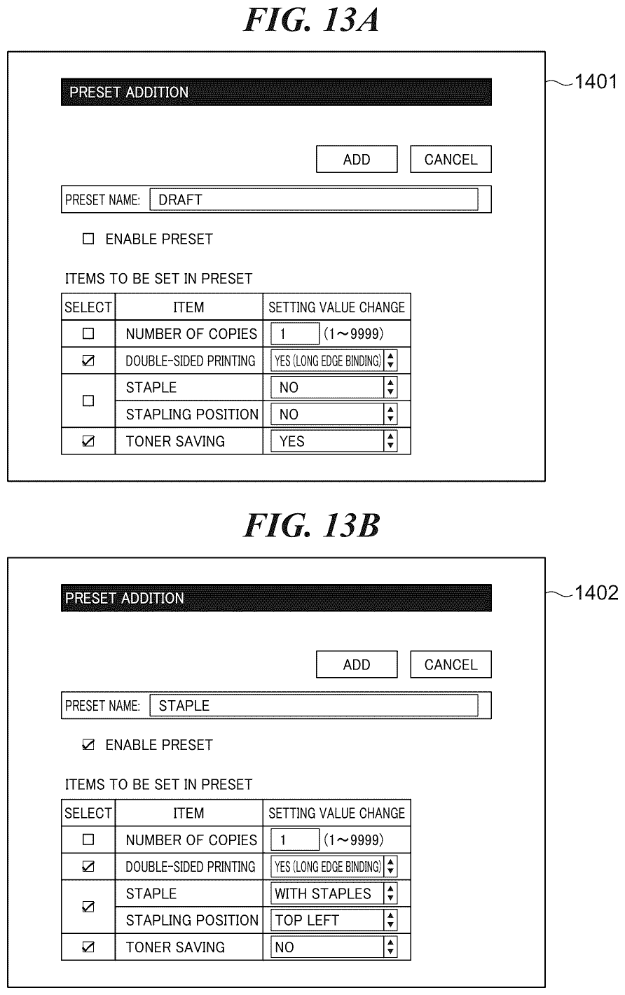

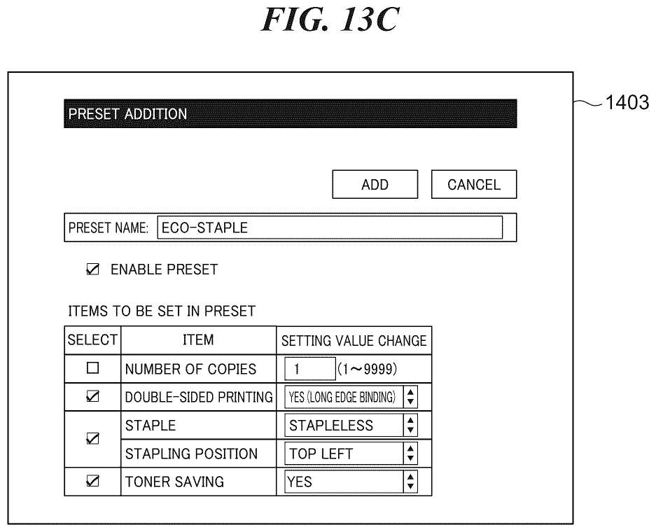

Next, the processing procedure of the printing apparatus will be described. FIG. 7A and FIG. 7B are flowcharts that show a processing from registering a preset in the printing apparatus to receiving a print job, in which a preset has been set, from the information processing apparatus and printing the received print job. FIG. 9A and FIG. 9B are diagrams that show examples of the preset management table. FIG. 10 is a diagram that shows an example of the print setting screen. FIG. 11A, FIG. 11B, and FIG. 11C are diagrams that show an example of a preset management screen. FIG. 13A, FIG. 13B, and FIG. 13C are diagrams that show an example of the print setting screen. Hereinafter, the details of the priority order determining processing performed in the step S607, the details of the preset information updating processing performed in the step S608, and the details of the preset management table updating processing performed in the step S619 will be described. As shown in FIG. 7A and FIG. 7B, in a step S701, the operation control unit 315 of the printing apparatus 101 determines whether or not there is a request to register a new preset from the operation unit 220 of the printing apparatus 101. As a result of the determination performed in the step S701, in the case of being determined that there is a request to register a new preset, the processing proceeds to a step S702. On the other hand, as the result of the determination performed in the step S701, in the case of being determined that there is no request to register a new preset, the processing proceeds to a step S703.

In the present embodiment, it is assumed that a preset management screen 1200 shown in FIG. 11A is implemented as a remote user interface (an RUI). Furthermore, only an administrator of the printing apparatus 101 is able to access this preset management screen 1200. That is, only the administrator of the printing apparatus 101 is able to register a new preset. The preset management screen 1200 includes a preset name 1201, a status 1202, a button 1203, the preset display priority order 1204, and a button 1205. The button 1205 is a “preset addition” button (a registering section) that is operated when additionally registering a new preset (a new print setting). The button 1203 is a “delete” button that is operated when deleting a registered preset. As shown in FIG. 11A, on the preset management screen 1200, “draft”, “staple”, and “eco-staple” are already registered as presets. In addition, it is possible to confirm the name of each preset by using the preset name 1201. It should be noted that “draft” refers to a trial print (a test print), and is used, for example, when confirming the printing status. “Staple” is one of the post-processing performed after printing, and is a processing (an operation) of binding together a plurality of printed sheets with a stapler, in other words, “staple” is binding with staples. “Eco-staple” is one of the post-processing performed after printing, similar to “staple”, but it differs from “staple” in that a plurality of printed sheets are bound together by pressure bonding without using staples, in other words, “eco-staple” is stapleless binding. In addition, by clicking each preset included in the preset name 1201, it is possible to transition to a preset editing screen 1220 shown in FIG. 11C. The status 1202 indicates whether the preset is enabled or disabled. It is possible to change enabled/disabled of the preset in the status 1202 by checking or not checking a checkbox 1222 on the preset editing screen 1220. In the case that the check box 1222 is checked, the preset is enabled, and on the other hand, in the case that the check box 1222 is not checked, the preset disabled. It should be noted that it is possible to update the setting details of the preset by operating a button 1221 on the preset editing screen 1220. The preset display priority order 1204 is operated when selecting a determining condition for determining the priority order of presets. The preset display priority order 1204 includes options 1206 that are “not designating the priority order”, “the descending order of the use frequency”, “the descending order of registration”, and “the most recently used order”. In addition to registering presets, the administrator of the printing apparatus 101 is able to set the priority order of preset display by using the preset display priority order 1204. In the options 1012 of an item 1011b of the print setting screen 1011 shown in FIG. 10, presets are displayed so as to be arranged in descending order from the most frequently used preset to the least frequently used preset. In the options 1012, as an example, “draft”, “staple”, and “eco-staple” are displayed side by side. As a result, the frequently used presets are displayed at the top, and therefore, even in the case that the number of registered presets increases, the user is able to easily select the frequently used presets.

By operating the button 1205 on the preset management screen 1200, transitioning to a preset addition screen 1210 shown in FIG. 11B. The preset addition screen 1210 includes a preset name 1211, a check box 1212, a check box 1213, an item 1214, a setting value change 1215, a button 1216, and a button 1217. It is possible to input the name of a preset to be added into the preset name 1211. By checking the checkbox 1212, it is possible to enable the preset. As a result, it is possible to actually use the added preset. By operating the setting value change 1215 with respect to the item 1214 for which the check box 1213 is checked, it is possible to perform the print setting of the preset to be added. For example, for the item 1214 “number of copies”, it is possible to input a value of “1 to 9999” for the number of copies to be printed by using the setting value change 1215. For the item 1214 “double-sided printing”, it is possible to select “not performing double-sided printing”, “performing double-sided printing with long edge binding”, or “performing double-sided printing with short edge binding” by using the setting value change 1215. For the item 1214 “staple”, it is possible to select “not performing stapling binding”, “performing stapling binding with staples”, or “performing stapling binding without staples (performing eco-stapling)” by using the setting value change 1215. For the item 1214 “stapling position”, it is possible to select “top left”, “bottom left”, “top right”, or “bottom right” by using the setting value change 1215. For the item 1214 “toner saving”, it is possible to select “not performing toner saving”, or “performing toner saving” by using the setting value change 1215. The button 1216 is an “add” button that is operated when the addition of the preset (the preset addition) is completed. The button 1217 is a “cancel” button that is operated when cancelling (stopping) adding a preset (the preset addition). In the present embodiment, it is possible to add the preset “draft” on a preset addition screen 1401 shown in FIG. 13A. In addition, it is possible to add the preset “staple” on a preset addition screen 1402 shown in FIG. 13B. Moreover, it is possible to add the preset “eco-staple” on a preset addition screen 1403 shown in FIG. 13C. In this way, in the case of be desired to register, in the printing apparatus 101, a plurality of presets (a plurality of print settings) having output conditions different from each other, it is possible to perform the registration of the plurality of presets (the plurality of print settings) as appropriate (a registering step).

In the step S702, the IPP attribute control unit 303 of the printing apparatus 101 adds a new preset to the preset management table 900A of the preset management unit 304. As shown in FIG. 9A, the preset management table 900A includes information that is a preset ID, a preset name, an IPP setting, a printing apparatus setting, a registration date and time, a last use date and time, and the number of times of use. In FIG. 9A, the preset “draft” added on the preset addition screen 1401 shown in FIG. 13A is set to the preset ID “1” and the preset name “draft”. In addition, the IPP setting is a print setting based on attributes and attribute values that are defined in the IPP, where “sides-two-sided-long-edge” indicates double-sided printing with long edge binding, and “print-quality=draft” indicates that print quality at draft level is sufficient. The printing apparatus setting is a print setting based on attributes and attribute values that are distributed within the printing apparatus 101, and also includes attributes unique to the printing apparatus 101 that are not defined in the IPP. Along with the setting of the preset name, the IPP setting, and the printing apparatus setting, the registration date and time, the last use date and time, and the number of times of use are initialized. The registration date and time is a date and time when the preset “draft” has been registered (for example, 2023 Apr. 1 12:21). The last use date and time is a last date and time when the preset “draft” has been used (for example, 2000 Jan. 1 00:00). The number of times of use is the number of times the preset “draft” has been used. It should be noted that it is assumed that the number of times of use is initialized to “0”. In addition, similar to the preset “draft”, the preset “staple” added on the preset addition screen 1402 shown in FIG. 13B is set to the preset ID “2”. Moreover, the preset “eco-staple” added on the preset addition screen 1403 shown in FIG. 13C is set to the preset ID “3”.

In the step S703, the IPP print service control unit 301 of the printing apparatus 101 determines whether or not there is a printer attribute obtaining request from the information processing apparatus 105. The printer attribute obtaining request is made in “Get-Printer-Attributes” of the printer attribute obtaining operation 1303 shown in FIG. 12 (see the step S606). Then, as a result of the determination performed in the step S703, in the case of being determined that there is a printer attribute obtaining request from the information processing apparatus 105, the processing proceeds to a step S704. On the other hand, as the result of the determination performed in the step S703, in the case of being determined that there is no printer attribute obtaining request from the information processing apparatus 105, the processing proceeds to a step S713.

In the step S704, the IPP attribute control unit 303 of the printing apparatus 101 creates the preset information 1010 shown in FIG. 10 with reference to a preset management table 900B shown in FIG. 9B. In the preset management table 900B, the registered preset “draft”, the registered preset “staple”, and the registered preset “eco-staple” are each used multiple times.

In a step S705, the IPP attribute control unit 303 confirms in what priority order the plurality of presets are displayed on the information processing apparatus 105 (confirms the priority order of preset display). In the present embodiment, the options 1206 on the preset management screen 1200 shown in FIG. 11A are “not designating the priority order”, “the descending order of the use frequency”, “the descending order of registration”, and “the most recently used order”. The administrator of the printing apparatus 101 is able to select one of these options 1206. In this way, in the step S704, by using the preset management screen 1200 (a determining section), it is possible to determine the priority order with respect to the preset “draft”, the preset “staple”, and the preset “eco-staple” under the determining condition selected from the options 1206 (a determining step). In addition, even in the case that one option 1206 is selected from among the options 1206, by operating the option 1206 (a changing section) again and selecting another option 1206 from among the options 1206, it is possible to change the determining condition for determining the priority order as appropriate. Moreover, in the case that “not designating the priority order” is selected from among the options 1206, it is possible to stop execution of determining the priority order. In this way, the option 1206 also functions as a switching section for switching presence/absence of the execution of determining the priority order.

In a step S706, the IPP attribute control unit 303 determines whether or not “the descending order of the use frequency” has been set in the priority order management unit 305. As a result of the determination performed in the step S706, in the case of being determined that “the descending order of the use frequency” has been set in the priority order management unit 305, the processing proceeds to a step S709. On the other hand, as the result of the determination performed in the step S706, in the case of being determined that “the descending order of the use frequency” has not been set in the priority order management unit 305, the processing proceeds to a step S707.

In the step S707, the IPP attribute control unit 303 determines whether or not “the descending order of registration” has been set in the priority order management unit 305. As a result of the determination performed in the step S707, in the case of being determined that “the descending order of registration” has been set in the priority order management unit 305, the processing proceeds to a step S710. On the other hand, as the result of the determination performed in the step S707, in the case of being determined that “the descending order of registration” has not been set in the priority order management unit 305, the processing proceeds to a step S708.

In the step S708, the IPP attribute control unit 303 determines whether or not “the most recently used order” has been set in the priority order management unit 305. As a result of the determination performed in the step S708, in the case of being determined that “the most recently used order” has been set in the priority order management unit 305, the processing proceeds to a step S711. On the other hand, as the result of the determination performed in the step S708, in the case of being determined that “the most recently used order” has not been set in the priority order management unit 305, the processing proceeds to a step S712.

In the step S709, the priority order management unit 305 refers to the preset management table 900B shown in FIG. 9B and updates the preset information so that the registered presets are arranged in a descending order of the number of times of use, and the processing proceeds to the step S712. Preset information 1020 shown in FIG. 10 is the result of updating the preset information 1010 so that the registered presets are arranged in the descending order of the number of times of use. In the preset information 1020, the preset name “staple” (a preset 902), which has been used 132 times (the number of times of use is 132), is arranged at the top. Next, the preset name “eco-staple” (a preset 903), which has been used 44 times (the number of times of use is 44), is arranged, and the preset name “draft” (a preset 901), which has been used 4 times (the number of times of use is 4), is arranged at the bottom.

In the step S710, the priority order management unit 305 refers to the preset management table 900B shown in FIG. 9B and updates the preset information so that the registered presets are arranged in a descending order of the registration date and time, and the processing proceeds to the step S712. Although not shown, in the case of the step S710, in the updated preset information, the preset name “eco-staple” (the preset 903) whose registration date and time is 2023 Apr. 8 13:04 is arranged at the top. Next, the preset name “staple” (the preset 902) whose registration date and time is 2023 Apr. 1 12:24 is arranged, and the preset name “draft” (the preset 901) whose registration date and time is 2023 Apr. 1 12:21 is arranged at the bottom.

In the step S711, the priority order management unit 305 refers to the preset management table 900B shown in FIG. 9B and updates the preset information so that the registered presets are arranged in a descending order of the last use date and time, and the processing proceeds to the step S712. Although not shown, in the case of the step S711, in the updated preset information, the preset name “eco-staple” (the preset 903) whose last use date and time is 2023 Jul. 4 17:21 is arranged at the top. Next, the preset name “draft” (the preset 901) whose last use date and time is 2023 Jul. 4 13:21 is arranged, and the preset name “staple” (the preset 902) whose last use date and time is 2023 Jun. 20 12:20 is arranged at the bottom.

As described above, in the steps S709 to S711, the priority order management unit 305 (a control unit) is able to exchange the priority order of the presets for each determining condition selected from the options 1206 (a control step).

In the step S712, the IPP print service control unit 301 (a transmitting unit) transmits the printer attributes of the printing apparatus 101 to the information processing apparatus 105 as a printer attribute response 1320 (see FIG. 12) (a transmitting step), and the processing proceeds to the step S713. It should be noted that the step S712 corresponds to the step S609 of the sequence diagram shown in FIG. 6. In addition, the printer attribute response 1320 includes the preset information updated by the priority order management unit 305 (for example, the preset information 1020), that is, includes the presets whose priority order has been exchanged. Therefore, “job-presets-supported” in the printer attribute response 1320 includes, for example, the preset information 1020 that has been updated in “the descending order of the use frequency”. It should be noted that transmission of the printer attribute response 1320 (the preset information) is performed in response to a request to transmit the print setting from the information processing apparatus 105. Thereby, the information processing apparatus 105 is able to receive the printer attribute response 1320 when the printer attribute response 1320 is required.

In the step S713, the IPP print service control unit 301 determines whether or not there is a print setting verification request from the information processing apparatus 105. The print setting verification request is made in the print setting verification operation 1305 “Validate-Job” (see the step S614). Then, as a result of the determination performed in the step S713, in the case of being determined that there is a print setting verification request from the information processing apparatus 105, the processing proceeds to a step S714. On the other hand, as the result of the determination performed in the step S713, in the case of being determined that there is no print setting verification request from the information processing apparatus 105, the processing proceeds to a step S715.

In the step S714, the IPP print service control unit 301 responds to the print setting verification request with the print setting verification response operation 1306. The step S714 corresponds to the step S614 of the sequence diagram shown in FIG. 6. In the step S714, for example, it is assumed that there is no problem with the print setting, the IPP print service control unit 301 responds with “successful-ok”.

In the step S715, the IPP print service control unit 301 determines whether or not there is a print job creation request from the information processing apparatus 105. The print job creation request is made in “Create-Job” of the print job creation operation 1307 (see the step S616). As a result of the determination performed in the step S715, in the case of being determined that there is a print job creation request from the information processing apparatus 105, the processing proceeds to a step S716. On the other hand, as the result of the determination performed in the step S715, in the case of being determined that there is no print job creation request from the information processing apparatus 105, the processing returns to the step S701, and the subsequent steps are sequentially executed.

In the step S716, the IPP print service control unit 301 creates a print job and transmits information about the created job including “job_id” to the information processing apparatus 105, and the processing proceeds to a step S717. This transmission to the information processing apparatus 105 is performed in the print job creation response operation 1308 (see the step S617).

In the step S717, the IPP print service control unit 301 determines whether or not there is transmission of a print document from the information processing apparatus 105 (whether or not a print document has been transmitted from the information processing apparatus 105). The transmission of the print document is performed in the print document transmission operation 1309 “Send-Document” (see the step S618). As a result of the determination performed in the step S717, in the case of being determined that there is transmission of a print document from the information processing apparatus 105, the processing proceeds to a step S718. On the other hand, as the result of the determination performed in the step S717, in the case of being determined that there is no transmission of a print document from the information processing apparatus 105, the processing remains on standby in the step S717.

In the step S718, the job control unit 306 of the printing apparatus 101, together with the IPP attribute control unit 303, the PDL analyzing unit 312, the RIP control unit 313, and the engine control unit 314, performs printing of the print document received in the step S717. In addition, when the printing of the print document received in the step S717 is completed, the job control unit 306 notifies the information processing apparatus 105 of the completion of the printing through the print document transmission response operation 1310. After executing the step S718, the processing proceeds to a step S719.

In the step S719, the IPP attribute control unit 303 determines whether or not the print job has used the preset. This determination is made based on whether or not the “Create-Job” of the print job creation operation 1307 (see the step S616) includes the “preset-name” attribute. In the case that the “Create-Job” of the print job creation operation 1307 includes the “preset-name” attribute, it is determined that the print job has used the preset. Then, as a result of the determination performed in the step S719, in the case of being determined that the print job has used the preset, the processing proceeds to a step S720. On the other hand, as the result of the determination performed in the step S719, in the case of being determined that the print job has not used the preset, the processing returns to the step S701, and the subsequent steps are sequentially executed.

In the step S720, the IPP attribute control unit 303 searches the preset management table 900B of the preset management unit 304 for the preset that has been used by the print job. Then, the IPP attribute control unit 303, on the preset management table 900B, updates information related to the preset that has been used by the print job. It should be noted that in the present embodiment, it is assumed that the printing apparatus 101 has a built-in timer. In this case, the IPP attribute control unit 303 is able to obtain current time information from the built-in timer and update the last use date and time and the number of times of use of the preset in the preset management table 900B.

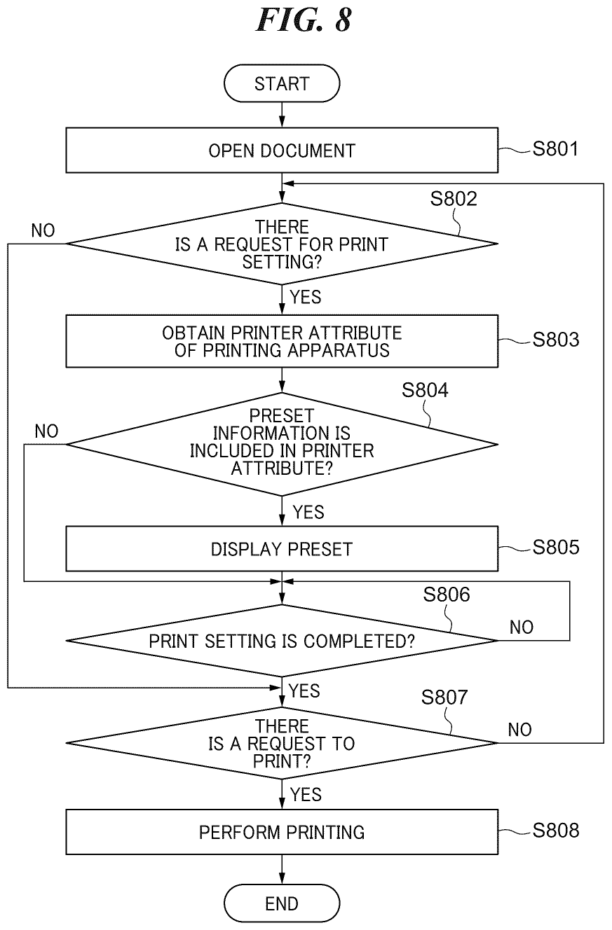

Next, the processing procedure of the information processing apparatus will be described. FIG. 8 is a flowchart that shows a processing executed by the information processing apparatus when obtaining the preset information from the printing apparatus and performing printing using the preset. As shown in FIG. 8, in a step S801, the application 501 of the information processing apparatus 105 opens a file to be printed.

In a step S802, the application 501 determines whether or not there is a request for print setting with respect to the file opened in the step S801. As a result of the determination performed in the step S802, in the case of being determined that there is a request for print setting with respect to the file opened in the step S801, the processing proceeds to a step S803. On the other hand, as the result of the determination performed in the step S802, in the case of being determined that there is no request for print setting with respect to the file opened in the step S801, the processing proceeds to a step S807.

In the step S803, the IPP client control unit 503 of the information processing apparatus 105 obtains the printer attributes (capability information) of the printing apparatus 101. By transmitting the printer attribute obtaining operation 1303 to the printing apparatus 101 (see the step S606) and receiving the printer attribute response operation 1304 from the printing apparatus 101 (see the step S609), it is possible to obtain the printer attributes of the printing apparatus 101.

In a step S804, the IPP client control unit 503 determines whether or not the preset information is included in the printer attributes obtained in the step S803. This determination is made based on whether or not “job-presets-supported” is included in the printer attributes. In the case that “job-presets-supported” is included in the printer attributes, it is determined that the preset information is included in the printer attributes. It should be noted that “job-presets-supported” is included in the printer attribute response operation 1304 and the printer attribute response 1320, and it is possible to determine presence/absence of the preset information based on “job-presets-supported”. Then, as a result of the determination performed in the step S804, in the case of being determined that the preset information is included in the printer attributes, the processing proceeds to a step S805. On the other hand, as the result of the determination performed in the step S804, in the case of being determined that the preset information is not included in the printer attributes, the processing proceeds to a step S806.

In the step S805, the print screen control unit 508 of the information processing apparatus 105 displays the print setting screen. In addition, the print screen control unit 508 refers to the preset information that has been determined in the step S804, and displays, on the print setting screen, a plurality of presets included in the preset information that has been determined in the step S804. The plurality of presets included in the preset information are displayed on the printing apparatus 101 in a state in which the priority order of the plurality of presets has been exchanged. Then, it is possible to select one preset from among these presets. For example, the presets included in the printer attribute response operation 1304 are “draft”, “staple”, and “eco-staple” in order from the top. In this case, the presets displayed on the information processing apparatus 105 are arranged in order from the top as “draft”, “staple”, and “eco-staple”, and become similar to the options 1012 on the print setting screen 1011 shown in FIG. 10.

The print setting screen 1011 includes an item 1011a, an item 1011b, an item 1011c, an item 1011d, an item 1011e, an item 1011f, an item 1011g, an item 1011h, and an item 1011i. The name of the printing apparatus 101 used for printing is displayed on the item 1011a. In the item 1011b, it is possible to select whether the preset (draft, staple, eco-staple) is enabled or the preset is disabled. It should be noted that the item 1011b is set to “none (the preset is disabled)” by default, but is not limited to this. It is possible to set the number of copies to be printed in the item 1011c. It is possible to designate a printing range in the item 1011d and the item 1011e. It is possible to designate color printing in the item 1011f. It is possible to designate double-sided printing in the item 1011g. It is possible to designate the number of pages per sheet (Nup) in the item 1011h. It is possible to designate finishing options such as stapling and punching in the item 1011i.

In addition, the presets included in the printer attribute response 1320 are “staple”, “eco-staple”, and “draft” in order from the top. This is the result of arranging the presets in the descending order of the use frequency through the processes of the steps S705, S706, S709, and S712 of the printing apparatus 101. In this case, like the preset information 1020 shown in FIG. 10, the display of the presets performed by the information processing apparatus 105 becomes “staple”, “eco-staple”, and “draft” in order from the top. Furthermore, options 1022 on a print setting screen 1021 also become “staple”, “eco-staple”, and “draft” in order from the top. This is similar to the preset display of “the descending order of the use frequency” that has been set in the printing apparatus 101.

In the step S806, the print screen control unit 508 of the information processing apparatus 105 determines whether or not the print setting is completed. As a result of the determination performed in the step S806, in the case of being determined that the print setting is completed, the processing proceeds to the step S807. On the other hand, as the result of the determination performed in the step S806, in the case of being determined that the print setting is not completed, the processing remains on standby in the step S806.

In the step S807, the print screen control unit 508 determines whether or not there is a request to print the file opened in the step S801 by using the printing apparatus 101. As a result of the determination performed in the step S807, in the case of being determined that there is a request to print the file opened in the step S801 by using the printing apparatus 101, the processing proceeds to a step S808. On the other hand, as the result of the determination performed in the step S807, in the case of being determined that there is no request to print the file opened in the step S801 by using the printing apparatus 101, the processing returns to the step S802, and the subsequent steps are sequentially executed.

In the step S808, the IPP client control unit 503 causes the printing apparatus 101 to perform printing. Thereby, the printing apparatus 101 is able to perform an output based on the preset selected by the information processing apparatus 105 (one output of “draft”, “staple”, and “eco-staple”) by using the printing unit 221 and the sheet processing unit 222 that constitute an output unit.

By the way, in the case that the preset display on the information processing apparatus 105 is always performed in the order of registered presets, depending on the total number of displayed presets, it may become difficult to find a desired preset, that is, a preset that the user want to select from among these presets. Therefore, with the printing apparatus 101, presets can be prioritized based on three conditions: the descending order of the use frequency, the descending order of the registration date and time, and the most recently used order. In addition, this priority order can be directly reflected in the preset display on the information processing apparatus 105. As a result, it is possible to easily find out a preset that the user want to select on the information processing apparatus 105, that is, it is possible to improve the operability when selecting the preset by using the information processing apparatus 105.

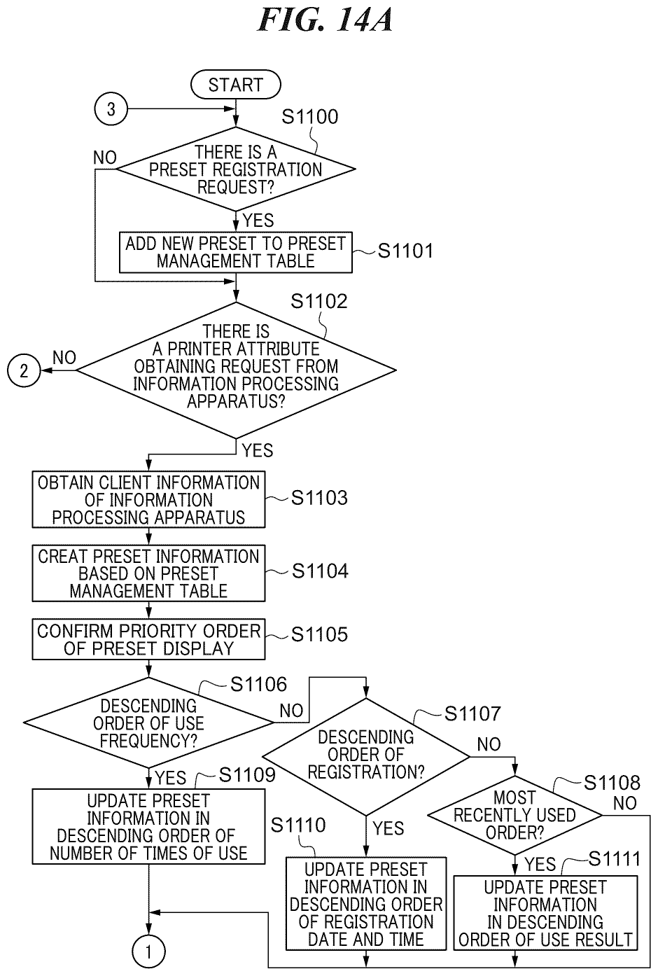

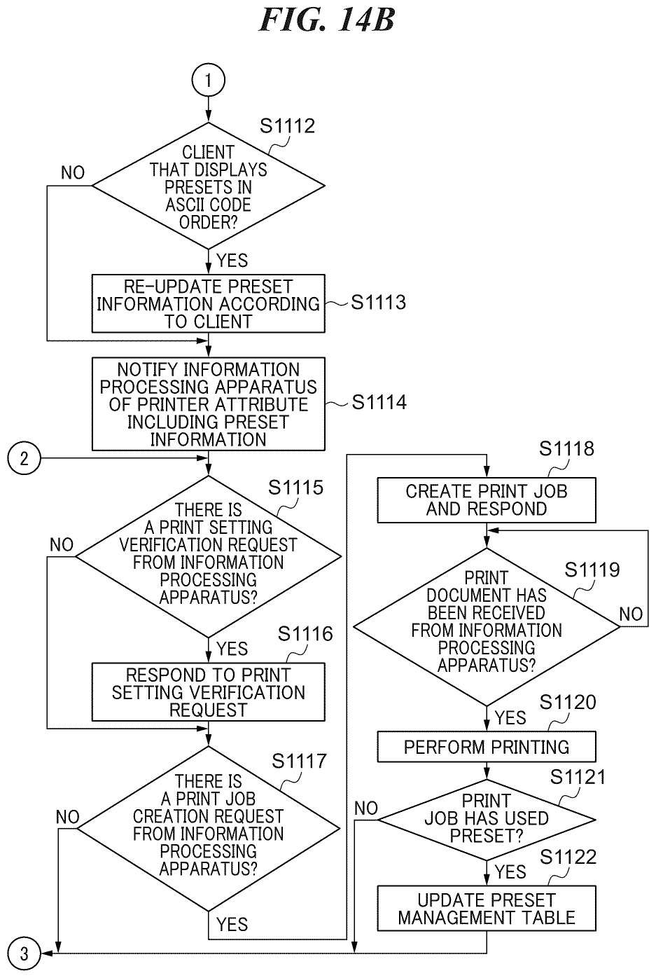

Hereinafter, a second embodiment will be described with reference to FIG. 14A and FIG. 14B, but the description of the second embodiment will focus on the differences from the first embodiment described above, and the description of similar matters will be omitted. FIG. 14A and FIG. 14B are flowcharts that show a processing from registering a preset in a printing apparatus to receiving a print job, in which a preset has been set, from an information processing apparatus and printing the received print job, in a printing system according to the second embodiment. As described above, the printing apparatus 101 is communicably connected to the two information processing apparatuses 105, that is, the terminal device 103 and the terminal device 104 (see FIG. 1). In the second embodiment, the printing apparatus 101 is able to identify the OS for each information processing apparatus 105. Furthermore, the printing apparatus 101 is able to transmit presets whose priority order has been exchanged according to the identified OS, that is, for each information processing apparatus 105.

As shown in FIG. 14A and FIG. 14B, steps S1100 to S1102 are the same as the steps S701 to S703 in the flowcharts shown in FIG. 7A and FIG. 7B.

In a step S1103, the IPP attribute control unit 303 obtains client information of the information processing apparatus 105 notified from the information processing apparatus 105 in the step S1102. This client information includes information about the OS of the information processing apparatus 105 and the version of the OS, etc. In addition, in the step S1103, the IPP attribute control unit 303 is able to obtain the information about the OS of the information processing apparatus 105 and the version of the OS from the client information obtained in the step S1102. In the IPP, the client information is defined in the “client-info” attribute, and it is possible to confirm the OS and the version of the OS.

Steps S1104 to S1111 are the same as the steps S704 to S711 in the flowcharts shown in FIG. 7A and FIG. 7B. After executing the step S1109, the processing proceeds to a step S1112. Furthermore, after executing the step S1110, the processing proceeds to the step S1112. Moreover, after executing the step S1111, the processing proceeds to the step S1112.

In the step S1112, the IPP attribute control unit 303 determines based on the client information obtained in the step S1103 whether or not the information processing apparatus 105 is a client that displays presets in ASCII code order. In the second embodiment, the IPP attribute control unit 303 functions as an identifying unit that identifies the OS for each information processing apparatus 105, and based on this identification result, the IPP attribute control unit 303 is able to determine whether or not the information processing apparatus 105 is a client that displays presets in ASCII code order. Then, as a result of the determination performed in the step S1112, in the case of being determined that the information processing apparatus 105 is a client that displays presets in ASCII code order, the processing proceeds to a step S1113. On the other hand, as the result of the determination performed in the step S1112, in the case of being determined that the information processing apparatus 105 is not a client that displays presets in ASCII code order, the processing proceeds to a step S1114.

In the step S1113, the priority order management unit 305 updates the preset information that has been updated in any one of the steps S1109 to S1111 again. In the second embodiment, the priority order management unit 305 updates the preset information 1020 shown in FIG. 10, which has been updated in the step S1109 so as to be arranged in the descending order of the number of times of use, again so as to become preset information 1030. Specifically, in the preset information 1020, the preset names are “staple”, “eco-staple”, and “draft”, but in the preset information 1030, the preset names are “1. staple”, “2. eco-staple”, and “3. draft”. Therefore, when updating again, a number is added to the beginning of the preset name.

In the step S1114, the IPP print service control unit 301 transmits the printer attributes of the printing apparatus 101, which includes the preset information 1030 re-updated by the priority order management unit 305, to the information processing apparatus 105 as a printer attribute response 1321 (see FIG. 12). The step S1114 corresponds to the step S609 of the sequence diagram shown in FIG. 6. In addition, the information processing apparatus 105 that displays presets in ASCII code order is able to receive the printer attribute response 1321. Thereby, the information processing apparatus 105 is able to display the presets in the same manner as options 1032 on a print setting screen 1031 shown in FIG. 10. This display is “1. staple”, “2. eco-staple”, and “3. draft” in order from the top, and is a display according to the settings of the printing apparatus 101.

Steps S1115 to S1118 are the same as the steps S713 to S716 in the flowcharts shown in FIG. 7A and FIG. 7B.

As described above, in the second embodiment, it is possible to switch the method of displaying the presets depending on the client information of the information processing apparatus 105, that is, whether or not the presets can be displayed in ASCII code order. As a result, in the case that the information processing apparatuses 105 equipped with various OSes and the printing apparatus 101 are communicably connected to each other, it becomes possible to display presets according to each information processing apparatus 105, and it is possible to improve convenience for users who use the presets.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-102482, filed on Jun. 22, 2023, which is hereby incorporated by reference herein in its entirety.

What is claimed is:

1. A printing apparatus that performs printing and is communicably connected to an information processing apparatus, which processes information,
the printing apparatus comprising:
at least one processor; and
a memory coupled to the processor storing instructions that, when executed by the processor, cause the processor to function as:
a registering section that registers a plurality of print settings, which have different output conditions including printing conditions when performing the printing with the printing apparatus;
a transmitting unit that transmits at least one print setting of the plurality of print settings to the information processing apparatus;
a determining section that, prior to transmission of the print setting performed by the transmitting unit, determines a priority order with respect to the plurality of print settings, which have been registered in the registering section; and
a control unit that exchanges an order of the plurality of print settings to be transmitted into the priority order when the transmitting unit transmits the plurality of print settings.

2. The printing apparatus according to claim 1, wherein
the transmitting unit transmits the plurality of print settings whose order has been exchanged into the priority order by the control unit.

3. The printing apparatus according to claim 2, wherein
in the information processing apparatus, the plurality of print settings are displayed in the exchanged priority order, and one print setting from among the plurality of print settings is capable of being selected, and
the printing apparatus comprises an output unit configured to perform an output based on the print setting selected by the information processing apparatus.

4. The printing apparatus according to claim 1, wherein
the information processing apparatus includes an operating system (OS),
the printing apparatus is communicably connected to a plurality of the information processing apparatuses,
the instructions, when executed by the processor, cause the processor to function as an identifying unit that identifies the OS for each the information processing apparatus, and
the transmitting unit transmits the plurality of print settings whose order has been exchanged into the priority order by the control unit according to the OS identified by the identifying unit.

5. The printing apparatus according to claim 1, wherein
the transmitting unit transmits the print setting in response to a request to transmit the print setting from the information processing apparatus.

6. The printing apparatus according to claim 1, wherein
the determining section determines the priority order based on one of the following determining conditions: a descending order of a use frequency of the print setting in the printing apparatus, a descending order of a registration date and time of the print setting registered in the registering section, and a descending order of a last use date and time of the print setting in the printing apparatus.

7. The printing apparatus according to claim 6, wherein
the instructions, when executed by the processor, cause the processor to function as a changing section that changes the determining condition.

8. The printing apparatus according to claim 1, wherein
the instructions, when executed by the processor, cause the processor to function as a switching section that switches presence/absence of execution of determining the priority order performed by the determining section.

9. The printing apparatus according to claim 1, wherein
the output conditions include post-processing conditions when performing post-processing after the printing.

10. A control method for controlling a printing apparatus that performs printing and is communicably connected to an information processing apparatus, which processes information,
the control method comprising:
a registering step of registering a plurality of print settings, which have different output conditions including printing conditions when performing the printing with the printing apparatus;
a transmitting step of transmitting at least one print setting of the plurality of print settings to the information processing apparatus;
a determining step of, prior to transmission of the print setting performed in the transmitting step, determining a priority order with respect to the plurality of print settings, which have been registered in the registering step; and
a control step of exchanging an order of the plurality of print settings to be transmitted into the priority order when the transmitting unit transmits the plurality of print settings.

11. A non-transitory computer-readable storage medium storing a program for causing a computer to execute a control method for controlling a printing apparatus that performs printing and is communicably connected to an information processing apparatus, which processes information,
the control method comprising:
a registering step of registering a plurality of print settings, which have different output conditions including printing conditions when performing the printing with the printing apparatus;
a transmitting step of transmitting at least one print setting of the plurality of print settings to the information processing apparatus;
a determining step of, prior to transmission of the print setting performed in the transmitting step, determining a priority order with respect to the plurality of print settings, which have been registered in the registering step; and
a control step of exchanging an order of the plurality of print settings to be transmitted into the priority order when the transmitting unit transmits the plurality of print settings.
